(19) United States
(12) Patent Application Publication
(10) Pub. No.: US 2006/0205448 A1
(43) Pub. Date: Sep. 14, 2006

(54) Communication device

(75) Inventor: Long-Jyh Pan, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/369,868

(22) Filed: Mar. 8, 2006

(30) Foreign Application Priority Data
Mar. 8, 2005 (TW) 94106958

(51) Int. Cl. H04M 1/00

(52) U.S. Cl. 455/575.1; 379/433.13

(57) ABSTRACT

A communication device comprises a first body and a display module. The first body comprises an audio speaker disposed on one end thereof, and the display module pivoted on the first body is moved between a first position and a second position with respect to the first body.

### BACKGROUND

The invention relates to a communication device, and in particular to a mobile phone having a rotatable display unit capable of switching between a first position and a second position with respect to the first body.

A conventional bar phone comprises a housing and a display unit fixed on the housing. If a user shows the data on the display unit to another, the bar phone must be reversed or directly handed to the other person.

A conventional foldable phone comprises an upper body having a fixed display unit and a lower body pivoted to the upper body. The lower body may be a host of the foldable phone. In general, the upper body and the display unit are synchronously rotated about an axis with respect to the lower body. In some foldable phones, even if the upper body is rotated about two different axes with respect to the lower body, the fixed display unit still moves with the upper body with respect to the lower body.

### SUMMARY

The invention provides a communication device such as a mobile phone having a display module rotatable with respect to a predetermined axis.

The mobile phone comprises a first body having an accommodation room, a second body, a display module, an image capturer, an audio speaker, an audio receiver, a circuit board, a pivot portion and a supporting portion. As the display module is pivoted to the first body, it is selectively rotated to a desired viewing position.

### DESCRIPTION OF THE DRAWINGS

The present invention can be more fully understood by reading the subsequent detailed description and examples with references made to the accompanying drawings, wherein:

FIG. 1 is a perspective view of a communication device of the first embodiment of the invention.

FIG. 2 is a schematic view of a communication device of the second embodiment of the invention.

FIG. 3 is a schematic view of an assembled communication device of the third embodiment of the invention.

FIG. 4 is an exploded schematic view of the communication device of FIG. 3.

FIG. 5 is another schematic view of the communication device of FIG. 3.

FIG. 6 is a partially exploded schematic view of the communication device of FIG. 3.

FIG. 7A is a schematic view of a communication device of the fourth embodiment of the invention.

FIG. 7B is an other perspective view of the communication device of FIG. 7A.

### DETAILED DESCRIPTION

Embodiments of the invention are related to a communication device such as a mobile phone, e.g. bar phone E1/E2 and foldable phone E3/E4.

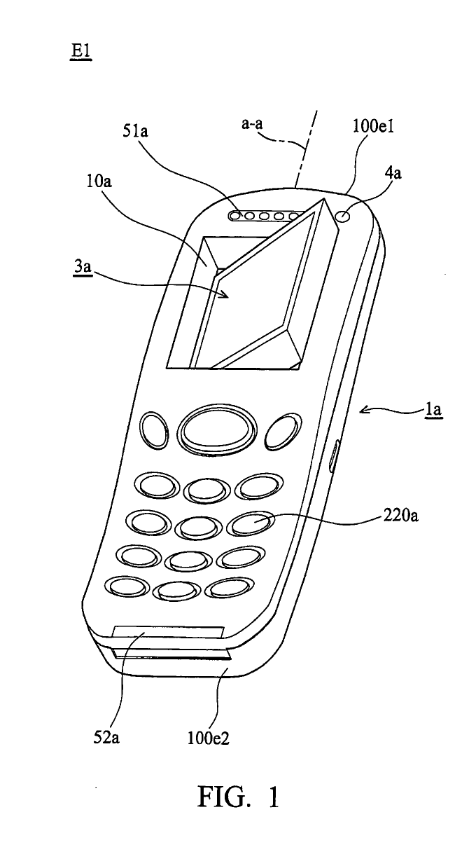

In FIG. 1, a bar phone E1 of the first embodiment comprises a first body 1a, a display module 3a, a plurality of keys 220a, an audio speaker 51a and an audio receiver 52a. The first body 1a comprises a first end 100e1, a second end 100e2 and an accommodation room 10a. The accommodation room 10a is hollow and formed in the middle of the first body 1a. The display module 3a received in the accommodation room 10a is pivoted to the first body 1a about an axis a-a centered the first body 1a, so that the display module 3a can be rotated to a desired viewing position with respect to the axis a-a. The keys 220a disposed on the first body 1a are electrically connected to a circuit board (not shown in Figs.). The audio speaker 51a and the audio receiver 52a respectively disposed on the first end 100e1 and the second end 100e2 of the first body 1a are spaced apart at a preferably designed distance, to decrease effectively interference therebetween.

When the display module 3a is rotated about the axis a-a, the display module 3a is switched among different positions, e.g. third and fourth embodiments as following.

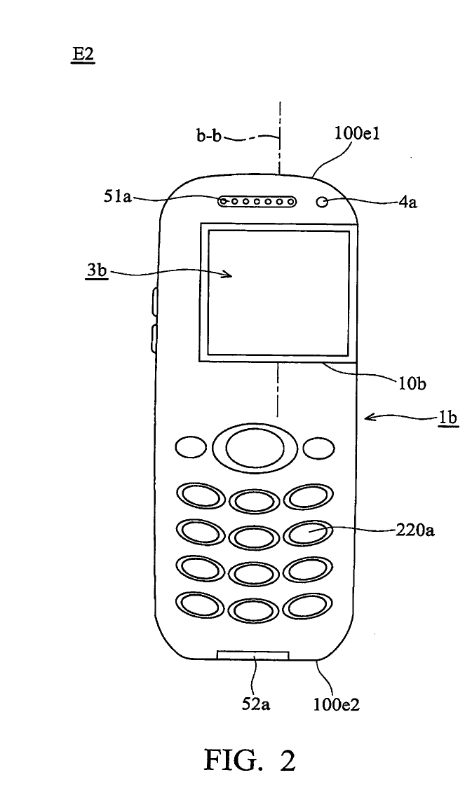

In FIG. 2, a bar phone E2 of the second embodiment differs from the bar phone E1 in that an accommodation room 10b is a U-shaped recess indented on one side of a first body 1b, i.e., not centered. As a display module 3b received in the accommodation room 10b is pivoted to the first body 1b about an axis b-b, the display module 3b is selectively rotated to a desired viewing position with respect to the axis b-b.

When the display module 3b is rotated about the axis b-b, the display module 3b is switched among different positions, e.g. third and fourth embodiments as described in the following.

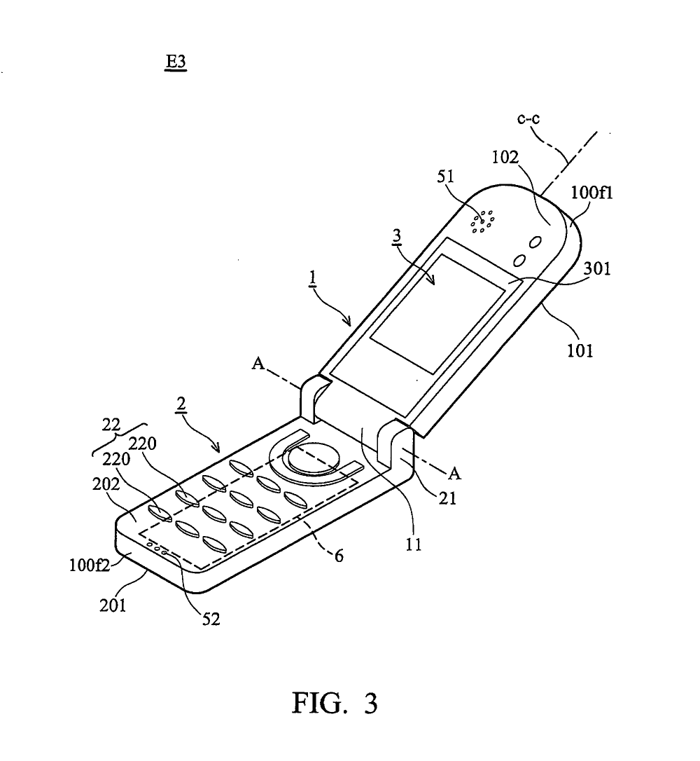

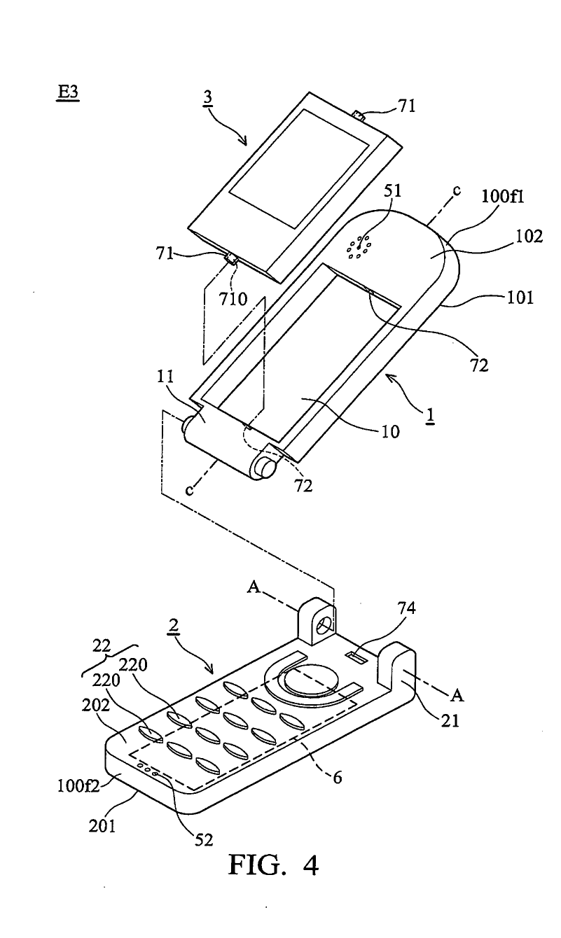

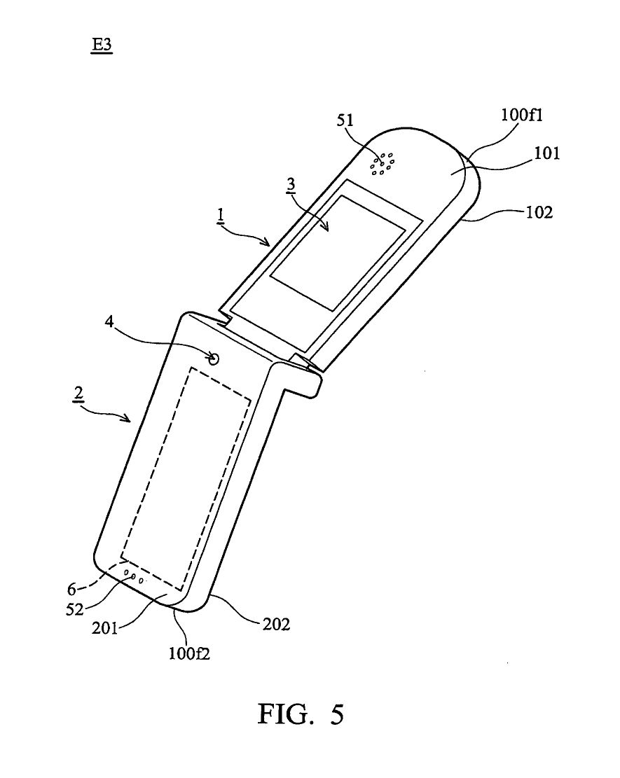

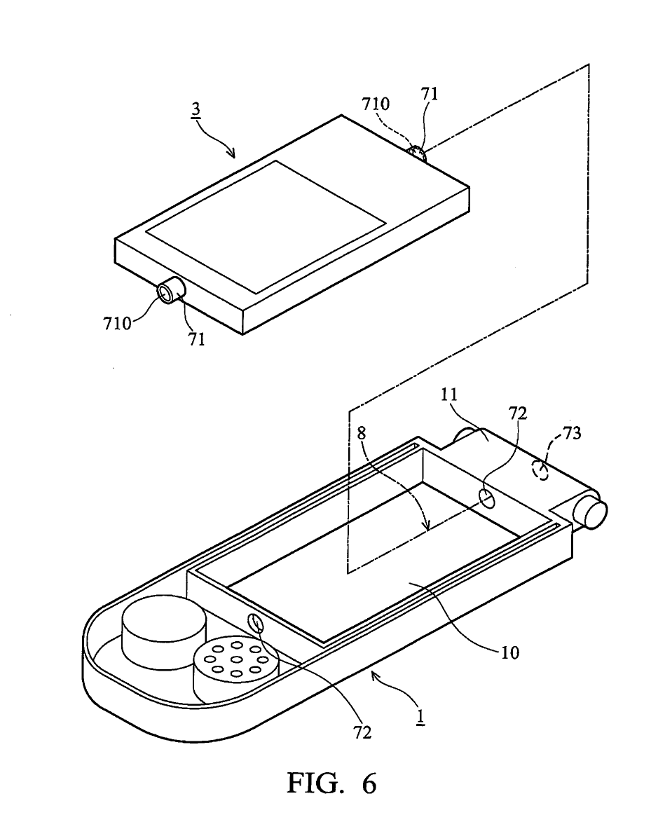

FIGS. 3 and 4 are assembled and disassembled view of the foldable phone E3 of the third embodiment. FIG. 5 is another perspective view of the foldable phone E3, and FIG. 6 is a partially exploded perspective view of the foldable phone E3.

In FIG. 3, the foldable phone E3 comprises a first body 1, a second body 2, a display module 3, an image capturer 4 such as a camera (shown in FIG. 5), an audio speaker 51, an audio receiver 52, a circuit board 6, a pivot portion 71, a supporting portion 72 (shown in FIG. 6) and a lead 8.

The first body 1 is connected to the second body 2 about an axis A-A, so that the first body 1 can be rotated with respect to the second body 2, e.g. in a collapsed or an opened mode. A first end 100f1 and a second end 100f2 of the foldable phone E3 are respectively located at the first body 1 and the second body 2.

The first body 1 comprises a first surface 101, a second surface 102 opposite to the first surface 101, an accommodation room 10, a first connection portion 11, a supporting portion 72 and a hole 73 (shown in FIG. 6). The accommodation room 10 is a rectangular passage penetrating the first surface 101 and the second surface 102. The first connection portion 11 is located at an interconnection of the first surface 101 and the second surface 102. The supporting portion 72 corresponding to the pivot portion 71 is formed on the inner surface of the accommodation room 10. The hole 73 extended from the supporting portion 72 is formed on the outer surface of the first connection portion 11.

The second body 2 is a host of the foldable phone E3, comprising a third surface 201, a fourth surface 202, a second connection portion 21, an index unit 22 and a hole 74. The second connection portion 21 corresponding to the first connection portion 11 of the first body 1 is disposed on a side of the second body 2. The index unit 22 formed on the fourth surface 202 of the housing 20 comprises a plurality of keys 220. The hole 74 adjacent to the second connection portion 21 is formed on the fourth surface 202, i.e., the hole 74 is a passage connecting to the interior of the second body 2.

The display module 3 received in the accommodation room 10 is pivoted to the first body 1 about an axis c-c centered on the first body 1a, so that the display module 3 can be rotated to a desired viewing position with respect to the axis c-c.

The image capturer 4 disposed on the third surface 201 (shown in FIG. 5) of the housing 20 is electrically connected to the display module 3.

The audio speaker 51 and the audio receiver 52 are respectively disposed on the first and second ends 100f1 and 100f2, so that interference therebetween can be effectively decreased.

The circuit board 6 build in the second body 2 is electrically connected the index unit 22, the image capturer 4 and the display module 3, so that data from the index unit 22 and image capturer 4 can be processed by the circuit board 6.

In FIG. 6, the pivot portion 71 is a connecting structure disposed on a side of the display module 3. The supporting portion 72 is a connecting structure formed on the inner wall of the accommodation room 10 and corresponding to the pivot portion 71. By connecting the supporting portion 72 to the pivot portion 71, the display module 3 is selectively rotated about the axis c-c with respect to the first body 1. Note that the pivot portion 71 is a male part (a protrusion) and the supporting portion 72 is a female part (a recess). In other embodiments, the pivot portion 71 can be a female part and the supporting portion 72 can be a male part.

A lead 8 (shown as a dotted line in FIG. 6) passing through the passage 710 of the pivot portion 71, the supporting portion 72, the hole 73 of the first body 1 and the hole 74 of the second body 2 connects the circuit board 6 in the second body 2 to the display module 3, the audio speaker 51 and the audio receiver 52.

When the display module 3 is rotated about the axis c-c, the display module 3 can be shifted between a first position (FIG. 3) and a second position (FIG. 5) with respect to the first body 1.

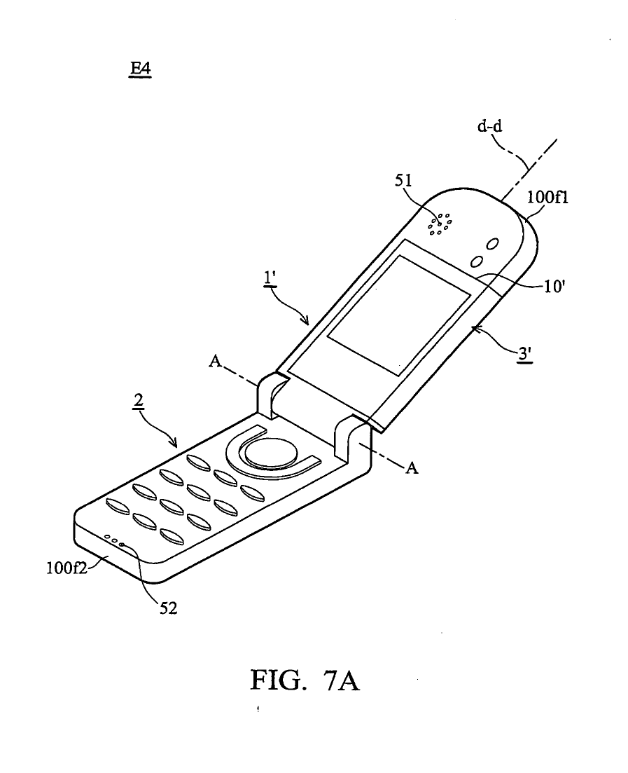

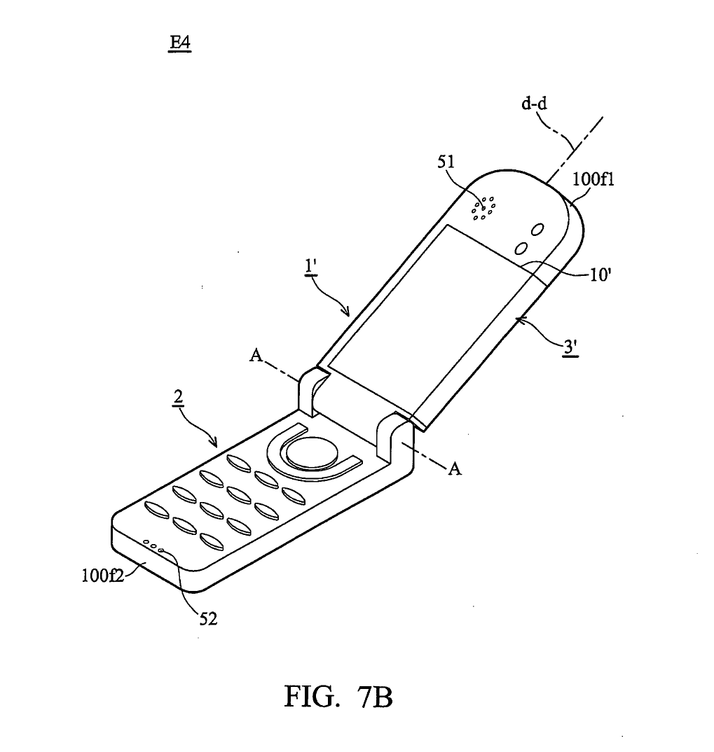

In FIGS. 7A and 7B, a foldable phone E4 of the fourth embodiment differs from the foldable phone E3 in that an accommodation room 10′ is a U-shaped recess indented on one side of a first body 1′. As a display module 3′ received in the accommodation room 10′ is pivoted to the first body 1′ about an axis d-d, the display module 3′ is selectively rotated to a desired viewing position.

When the display module 3′ is rotated about the axis d-d, the display module 3′ is switched among different positions for viewing, e.g. the positions in FIGS. 7A and 7B, respectively.

While the invention has been described with respect to preferred embodiment, it is to be understood that the invention is not limited thereto the disclosed embodiments, but, on the contrary, is intended to accommodate various modifications and equivalent arrangements included within the spirit and scope of the appended claims.

What is claimed is:

1. A communication device, comprising:
a first body including a first end;
an audio speaker disposed on the first end; and
a display module disposed on the first body, movably shifted between a first position and a second position with respect to the first body.

2. The communication device as claimed in claim 1, wherein the display module is connected the first body about an axis and shifted between the first position and the second position with respect to the axis.

3. The communication device as claimed in claim 2 further comprising:
a pivot portion having a passage connected the display module and the first body; and
a lead electrically connected to the display module and the first body via the passage.

4. The communication device as claimed in claim 1 further comprising an image capturer electrically connected to the display module.

5. The communication device as claimed in claim 1 further comprising an audio receiver disposed on a second end of the first body.

6. The communication device as claimed in claim 1 further comprising an index unit.

7. The communication device as claimed in claim 6, wherein the index unit comprises a plurality of keys.

8. The communication device as claimed in claim 2 further comprising a second body connected to the first body.

9. The communication device as claimed in claim 8 further comprising an image capturer disposed on the second body and electrically connected to the display module.

10. The communication device as claimed in claim 8 further comprising an audio receiver disposed on the second body.

11. The communication device as claimed in claim 8 further comprising:
a pivot portion having a passage connected the display module and the first body; and
a lead electrically connected to the display module and the first body via the passage.

12. The communication device as claimed in claim 8 further comprising an index unit disposed on the second body.

13. The communication device as claimed in claim 12, wherein the index unit comprises a plurality of keys.
